(19) United States
(12) Patent Application Publication
(10) Pub. No.: US 2023/0384455 A1
(43) Pub. Date: Nov. 30, 2023

(54) LIDAR SENSOR INCLUDING SPATIAL LIGHT MODULATOR TO DIRECT FIELD OF ILLUMINATION

(71) Applicant: Continental Autonomous Mobility US, LLC, Auburn Hills, MI (US)

(72) Inventors: Daniel Cashen, Troy, MI (US); Esaias Pech Aguilar, Sterling Heights, MI (US)

(73) Assignee: Continental Autonomous Mobility US, LLC, Auburn Hills, MI (US)

(21) Appl. No.: 17/804,745

(22) Filed: May 31, 2022

(51) Int. Cl. G01S 17/894; G01S 7/484

(52) U.S. Cl. CPC G01S 17/894; G01S 7/484; G01S 17/931

(57) ABSTRACT

A LiDAR sensor includes a light emitter, a spatial light modulator positioned to direct light from the light emitter into a field of illumination, and a light detector having a field of view overlapping the field of illumination. The LiDAR sensor includes a controller programmed to identify an area of interest based on light detected by the light detector in a previous subframe and adjust the spatial light modulator to direct light into the field of illumination at an intensity that is greater at the area of interest than at an adjacent area of the field of view.

### BACKGROUND

A non-scanning LiDAR (Light Detection And Ranging) sensor, e.g., a solid-state LADAR sensor includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LADAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The LiDAR sensor may be mounted on a vehicle to detect objects in the environment surrounding the vehicle and to detect distances of those objects for environmental mapping. The output of the LiDAR sensor may be used, for example, to autonomously or semi-autonomously control operation of the vehicle, e.g., propulsion, braking, steering, etc. Specifically, the LiDAR sensor may be a component of or in communication with an advanced driver-assistance system (ADAS) of the vehicle.

For a long-range detection, a LiDAR sensor may operate with a higher intensity light source to increase the likelihood of illumination at long range and a more sensitive light detector that senses low intensity light returns from long range. For short-range detection, a LiDAR sensor may operate with lower intensity light source and a less sensitive light detector to reduce the likelihood that detection at short range overloads the light detector. Accordingly, a vehicle may include multiple LiDAR sensors for detection at various ranges.

### BRIEF DESCRIPTION OF THE DRAWINGS

FIG. 1 is a perspective view of a vehicle including a LiDAR sensor.

FIG. 2 is a perspective view of the LiDAR sensor.

FIG. 3 is a schematic cross-section of the LiDAR sensor.

FIG. 4 is a block diagram of the LiDAR sensor.

FIG. 5 is a perspective view of a light detector of the LiDAR assembly.

FIG. 5A is a magnified view of the light detector schematically showing an array of photodetectors.

FIG. 6A is an example field of view of the LiDAR sensor.

FIG. 6B is an example field of view of the LiDAR sensor with an example area of interest identified based on a previous subframe. A spatial light modulator of the LiDAR sensor directs light from a light emitter of the LiDAR sensor to illuminate the area of interest in an upcoming subframe.

FIG. 6C is an example field of view of the LiDAR sensor with an example area of interest identified based on a previous subframe. The spatial light modulator of the LiDAR sensor directs light from the light emitter of the LiDAR sensor to illuminate the area of interest in an upcoming subframe.

FIG. 6D is an example field of view of the LiDAR sensor with the example areas of interest from FIGS. 6B and 6C for reference and with a plurality sample areas of interest to sample parts of the field of view that have not been recently illuminated in the example areas of interest of FIGS. 6B and 6C. Any one of sample areas of interest may be illuminated in an upcoming subframe to sample other areas of the field of view.

FIG. 6E is an example field of view of the LiDAR sensor with an example area of interest identified based on object detection in the sampling the field of view with the sample areas of interest in FIG. 6D. The spatial light modulator of the LiDAR sensor directs light from the light emitter of the LiDAR sensor to illuminate the area of interest in an upcoming subframe.

FIG. 7 is a block diagram of a method of operating the LiDAR sensor.

### DETAILED DESCRIPTION

With reference to the Figures, wherein like numerals indicate like parts throughout the several views, a LiDAR sensor 10 includes a light emitter 12, a spatial light modulator 14 positioned to direct light from the light emitter 12 into a field of illumination FOI, and a light detector 16 having a field of view FOV overlapping the field of illumination FOI. The LiDAR sensor 10 includes a controller 18 programmed to: activate the light emitter 12 and the spatial light modulator 14 to illuminate at least a portion of the field of view; repeat activation of the light detector 16 to detect light in the field of view to generate a plurality of detection subframes that are combined into a single detection frame; for a subsequent subframe, identify an area of interest AOI based on light detected by the light detector 16 in a previous subframe, the area of interest AOI being in the field of view FOV of the light detector 16 and being smaller than the field of view FOV of the light detector 16; and adjust the spatial light modulator 14 to direct light into the field of illumination FOI at an intensity that is greater at the area of interest AOI than at an adjacent area of the field of view FOV.

Since the spatial light modulator 14 directs light at a higher intensity at the area of interest AOI, one LiDAR sensor 10 can be used to illuminate a larger portion of the field of view FOV of the light detector 16 with relatively low-intensity illumination for close objects and to illuminate a smaller portion of the field of view FOV of the light detector 16 with relatively high-intensity illumination for distant objects. In other words, the LiDAR sensor 10 may change resolution of future subframes based on detection of objects in previous subframes. This reduces or eliminates the need for separate LiDAR sensors for near-field and far-field detections. The LiDAR sensor 10 may move the area of interest AOI to target areas of the field of view FOV that previously contained detected objects. These subframes with targeted areas of interest are then combined into a frame. The subframes and frames may be used for operation of a vehicle 20, as described further below.

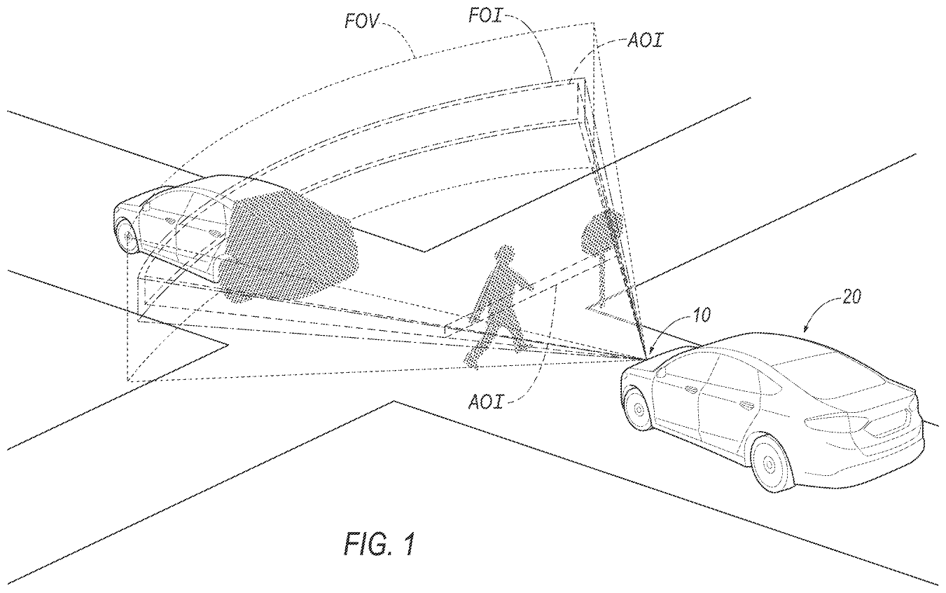

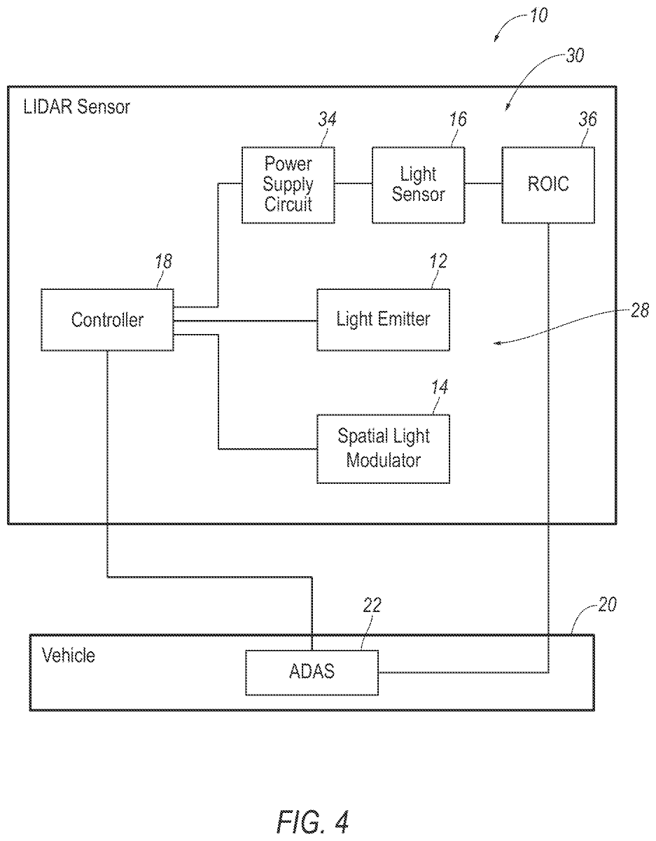

The LiDAR sensor 10 is shown in FIG. 1 as being mounted on a vehicle 20. In such an example, the LiDAR sensor 10 is operated to detect objects in the environment surrounding the vehicle 20 and to detect distance, i.e., range, of those objects for environmental mapping. The output of the LiDAR sensor 10 may be used, for example, to autonomously or semi-autonomously control operation of the vehicle 20, e.g., propulsion, braking, steering, etc. Specifically, the LiDAR sensor 10 may be a component of or in communication with an advanced driver-assistance system (ADAS) 22 of the vehicle 20 (FIG. 4). The LiDAR sensor 10 may be mounted on the vehicle 20 in any suitable position and aimed in any suitable direction. As one example, the LiDAR sensor 10 is shown on the front of the vehicle 20 and directed forward. The vehicle 20 may have more than one LiDAR sensor 10 and/or the vehicle 20 may include other object detection systems, including other LiDAR systems. The vehicle 20 shown in the figures is a passenger automobile. As other examples, the vehicle 20 may be of any suitable manned or un-manned type including a plane, satellite, drone, watercraft, etc.

The LiDAR sensor 10 may be a non-scanning sensor. For example, the LiDAR sensor 10 may be a solid-state LiDAR. In such an example, the LiDAR sensor 10 is stationary relative to the vehicle 20 in contrast to a mechanical LiDAR, also called a rotating LiDAR, that rotates 360 degrees. The solid-state LiDAR sensor 10, for example, may include a casing 24 that is fixed relative to the vehicle 20, i.e., does not move relative to the component of the vehicle 20 to which the casing 24 is attached, and components of the LiDAR sensor 10 are supported in the casing 24. As a solid-state LiDAR, the LiDAR sensor 10 may be a flash LiDAR sensor. In such an example, the LiDAR sensor 10 emits pulses, i.e., flashes, of light into a field of illumination FOI. More specifically, the LiDAR sensor 10 may be a 3D flash LiDAR sensor that generates a 3D environmental map of the surrounding environment. In a flash LiDAR sensor, the FOI illuminates a field of view FOV of the light detector 16. Another example of solid-state LiDAR includes an optical-phase array (OPA). As described further below, the LiDAR sensor 10 includes a spatial light modulator 14 that steers the light emitted from the LiDAR sensor 10 into the field of illumination FOI.

The LiDAR sensor 10 emits infrared light and detects (i.e., with photodetectors 26) the emitted light that is reflected by an object in the field of view FOV, e.g., pedestrians, street signs, vehicles, etc. Specifically, the LiDAR sensor 10 includes a light-emission system 28, a light-receiving system 30, and the controller 18 that controls the light-emission system 28 and the light-receiving system 30.

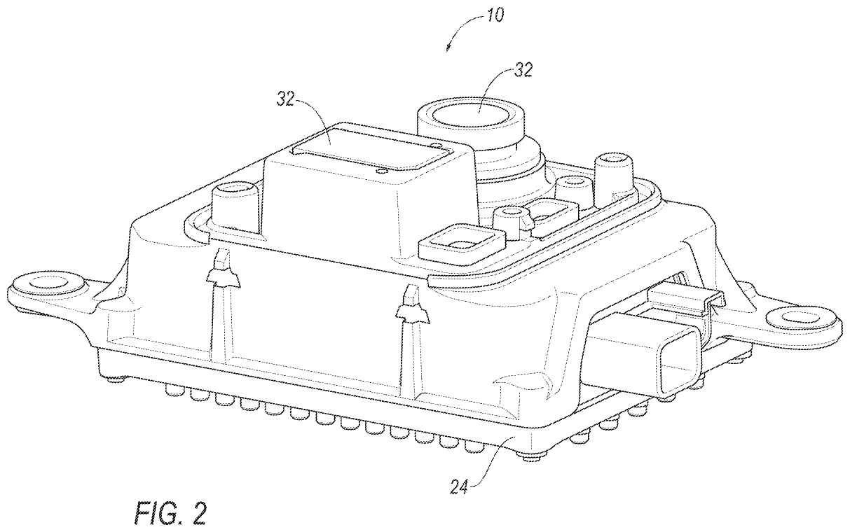

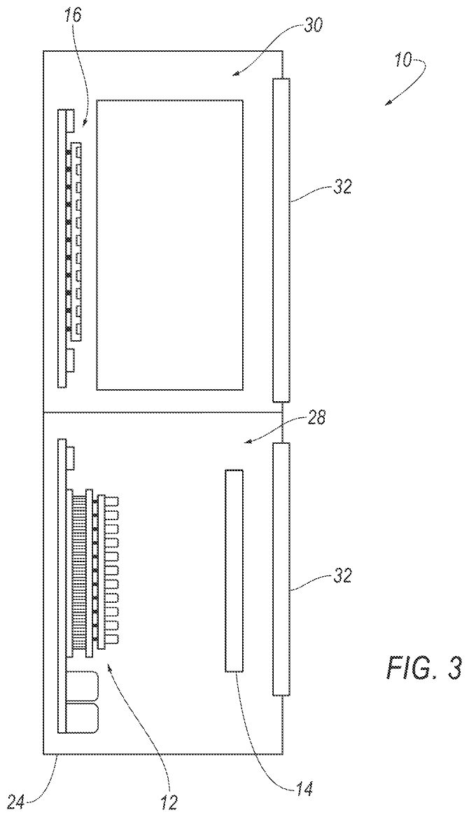

With reference to FIGS. 2-3, the LiDAR sensor 10 may be a unit. Specifically, the casing 24 supports the light-emission system 28 and the light-receiving system 30. The casing 24 may enclose the light-emission system 28 and the light-receiving system 30. The casing 24 may include mechanical attachment features to attach the casing 24 to the vehicle 20 and electronic connections to connect to and communicate with electronic system of the vehicle 20, e.g., components of the ADAS 22. At least one window 32 extends through the casing 24. Specifically, the casing 24 includes at least one aperture and the window 32 extends across the aperture to pass light from the LiDAR sensor 10 into the field of illumination FOI and to receive light into the LiDAR sensor 10 from the field of view FOV. The casing 24, for example, may be plastic or metal and may protect the other components of the LiDAR sensor 10 from moisture, environmental precipitation, dust, etc. In the alternative to the LiDAR sensor 10 being a unit, components of the LiDAR sensor 10, e.g., the light-emission system 28 and the light-receiving system 30, may be separated and disposed at different locations of the vehicle 20.

With reference to FIGS. 3-4, the light-emission system 28 may include one or more light emitter 12. The light-emission system 28 may include optical components such as a lens package, lens crystal, pump delivery optics, etc. The optical components are between the light emitter 12 and the window 32. Thus, light emitted from the light emitter 12 passes through the optical components before exiting the casing 24 through the window 32. The optical components include at least one optical element (not numbered) and may include, for example, a diffuser, a collimating lens, transmission optics, etc. The optical components direct, focus, and/or shape the light into the field of illumination FOI. The optical element may be of any suitable type that shapes and directs light from the light emitter 12 toward the window 32. For example, the optical element may be or include a diffractive optical element, a diffractive diffuser, a refractive diffuser, etc. The spatial light modulator 14 may be the or at at least one of the optical elements. The optical element may be transmissive and, in such an example, may be transparent. As another example, the optical element may be reflective, a hologram, etc.

The light-emission system 28 includes the spatial light modulator 14. The spatial light modulator 14 creates a phase pattern that diffracts light, as is known. The spatial light modulator 14 modulates the light from the light emitter 12. Specifically, the spatial light modulator 14 is designed to modulate the intensity of the light from the light emitter 12 and pattern and direct the light from the light emitter 12 to a desired size, shape, and position in the field of view. The spatial light modulator 14 may be designed to control the intensity, shape, and/or position of the light independently for each emission of light by the light emitter 12, i.e., may vary intensity, pattern, and/or position emission-by-emission.

In particular, the spatial light modulator 14 is designed to vary the intensity of the light in the field of illumination. Specifically, the spatial light modulator 14 may disperse light from the light emitter 12 across the entire field of view FOV or a relatively large portion of the field of view FOV at a relatively lower intensity and may concentrate light from the light emitter 12 across a relatively smaller portion of the field of view FOV at a relatively higher intensity. In addition to modulating the intensity of the light from the light emitter 12, the spatial light modulator 14 is designed to pattern the light from the light emitter 12 in the field of view FOV. Specifically, in instances in which the spatial light modulator 14 illuminates less than the entire field of view FOV of light detector 16, the spatial light modulator 14 controls the size and shape of light, i.e., the pattern of the light, that is emitted into the field of view FOV. In addition to modulating the intensity of the light and shaping the light from the light emitter 12 into the field of illumination FOI, the spatial light modulator 14 is designed to steer the light from the light emitter 12 in the field of illumination, i.e., the spatial light modulator 14 operates as a beam-steering device. In other words, in instances in which the spatial light modulator 14 varies the pattern of the light to illuminate less than the entire field of view FOV, the spatial light modulator 14 steers the light to a selected portion of the field of view FOV. The controller 18 controls the emission of light by the light emitter 12 as well as the intensity, pattern, and position of the light in the field of view FOV.

The spatial light emitter 12 may be, for example, a liquid-crystal lens. In such an example, the liquid-crystal lens has a light-shaping region including an array of liquid-crystal pixels, as is known. The liquid-crystal pixels modulate the light from the light emitter 12 by changing reflectivity and/or transmissivity in specified patterns to control the intensity, pattern, and position in the field of illumination FOI. The liquid-crystal lens may generate a variety of patterns, e.g., depending on an electrical field applied to the liquid-crystal pixels. The electrical field may be applied, for example, in response to a command from the controller 18.

The light emitter 12 is designed to emit light into the field of illumination FOI. Specifically, the light emitter 12 is positioned to emit light at the spatial light modulator 14 directly from the light emitter 12 or indirectly from the light emitter 12 through intermediate components. The spatial light modulator 14 is positioned to direct light from the light emitter 12 into the field of illumination FOI. The light emitter 12 is aimed at the spatial light modulator 14, i.e., substantially all of the light emitted from the light emitter 12 reaches the spatial light modulator 14. The spatial light modulator 14 modulates the light from the light emitter 12, as discussed above, for illuminating the field of illumination FOI exterior to the LiDAR sensor 10. In other words, the spatial light modulator 14 is designed to control the intensity, pattern, and position of the light for each emission of light by the light emitter 12. The light from the spatial light modulator 14 may travel directly to the window 32 or may interact with additional components between the spatial light modulator 14 and the window 32 before exiting the window 32 into the field of illumination FOI.

The light emitter 12 emits light for illuminating objects for detection. The controller 18 is in communication with the light emitter 12 for controlling the emission of light from the light emitter 12 and the controller 18 is in communication with the spatial light modulator 14 for varying the intensity of the light and patterning and aiming the light from the LiDAR sensor 10 into the field of illumination FOI.

The light emitter 12 emits light into the field of illumination FOI for detection by the light-receiving system 30 when the light is reflected by an object in the field of view FOV. In the example in which the LiDAR sensor 10 is flash LiDAR, the light emitter 12 emits shots, i.e., pulses, of light into the field of illumination FOI for detection by the light-receiving system 30 when the light is reflected by an object in the field of view FOV to return photons to the light-receiving system 30. Specifically, the light emitter 12 emits a series of shots. As an example, the series of shots may be 1,500-2,500 shots, e.g., for one detection frame as described further below. The light-receiving system 30 has a field of view FOV that overlaps the field of illumination FOI and receives light reflected by surfaces of objects, buildings, road, etc., in the FOV. In other words, the light-receiving system 30 detects shots emitted from the light emitter 12 and reflected in the field of view FOV back to the light-receiving system 30, i.e., detected shots. The light emitter 12 may be in electrical communication with the controller 18, e.g., to provide the shots in response to commands from the controller 18.

The light emitter 12 may be, for example, a laser. The light emitter 12 may be, for example, a semiconductor light emitter 12, e.g., laser diodes. In one example, the light emitter 12 is a vertical-cavity surface-emitting laser (VCSEL). As another example, the light emitter 12 may be a diode-pumped solid-state laser (DPSSL). As another example, the light emitter 12 may be an edge emitting laser diode. The light emitter 12 may be designed to emit a pulsed flash of light, e.g., a pulsed laser light. Specifically, the light emitter 12, e.g., the VCSEL or DPSSL or edge emitter, is designed to emit a pulsed laser light or train of laser light pulses. The light emitted by the light emitter 12 may be, for example, infrared light having a wavelength based on the temperature of the light emitter 12, as described below. In the alternative to infrared light, the light emitted by the light emitter 12 may be of any suitable wavelength. The LiDAR sensor 10 may include any suitable number of light emitters 12, i.e., one or more in the casing 24. In examples that include more than one light emitter 12, the light emitter 12s may be arranged in a column or in columns and rows. In examples that include more than one light emitter 12, the light emitter 12s may be identical or different and may each be controlled by the controller 18 for operation individually and/or in unison.

The light emitter 12 may be stationary relative to the casing 24. In other words, the light emitter 12 does not move relative to the casing 24 during operation of the LiDAR sensor 10, e.g., during light emission. The light emitter 12 may be mounted to the casing 24 in any suitable fashion such that the light emitter 12 and the casing 24 move together as a unit.

The light-receiving system 30 has a field of view FOV that overlaps the field of illumination FOI and receives light reflected by objects in the FOV. Stated differently, the field of illumination FOI generated by the light-emitting system overlaps the field of view FOV of the light-receiving system 30. The light-receiving system 30 may include receiving optics and a light detector 16 having the array of photodetectors 26. The light-receiving system 30 may include a window 32 and the receiving optics (not numbered) may be between the window 32 and the light detector 16. The receiving optics may be of any suitable type and size.

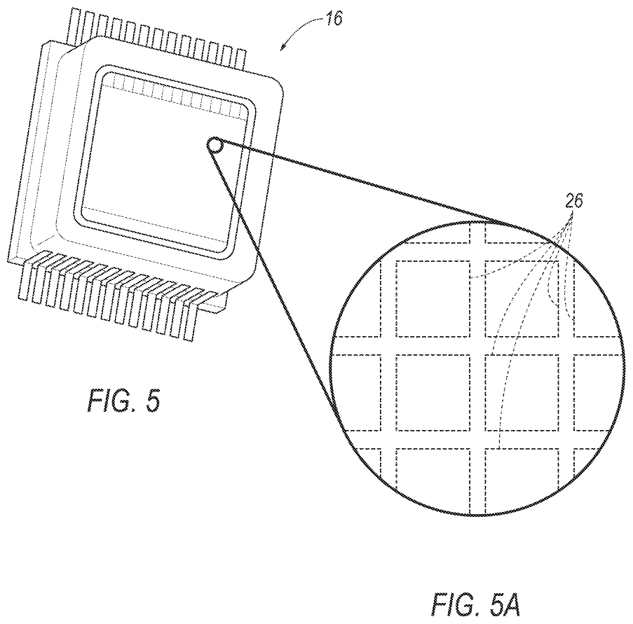

The light detector 16 includes a chip and the array of photodetectors 26 is on the chip. The chip may be silicon (Si), indium gallium arsenide (InGaAs), germanium (Ge), etc., as is known. The chip and the photodetectors 26 are shown schematically in FIGS. 5 and 5A. The array of photodetectors 26 is 2-dimensional. Specifically, the array of photodetectors 26 includes a plurality of photodetectors 26 arranged in a columns and rows (schematically shown in FIGS. 5 and 5A).

Each photodetector 26 is light sensitive. Specifically, each photodetector 26 detects photons by photo-excitation of electric carriers. An output signal from the photodetector 26 indicates detection of light and may be proportional to the amount of detected light. The output signals of each photodetector 26 are collected to generate a scene detected by the photodetector 26.

The photodetector 26 may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors 26, phototransistors, photoconductive detectors, phototubes, photomultipliers, etc. The photodetectors 26 may each be of the same type.

Avalanche photodiodes (APD) are analog devices that output an analog signal, e.g., a current that is proportional to the light intensity incident on the detector. APDs have high dynamic range as a result but need to be backed by several additional analog circuits, such as a transconductance or transimpedance amplifier, a variable gain or differential amplifier, a high-speed A/D converter, one or more digital signal processors (DSPs) and the like.

In examples in which the photodetectors 26 are SPADs, the SPAD is a semiconductor device, specifically, an APD, having a p-n junction that is reverse biased (herein referred to as “bias”) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates the arrival time of the detected photon. In other words, the SPAD is a triggering device of which usually the leading edge determines the trigger.

The SPAD operates in Geiger mode. “Geiger mode” means that the APD is operated above the breakdown voltage of the semiconductor and a single electron-hole pair (generated by absorption of one photon) can trigger a strong avalanche. The SPAD is biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by a power-supply circuit 34 to a voltage above the SPAD breakdown voltage so that the next photon can be detected.

Each photodetector 26 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the field of view FOVs. By merging these distances with the position of photodetectors 26 at which these data originated and relative positions of these photodetectors 26 at a time that these data were collected, the LiDAR sensor 10 (or other device accessing these data) can reconstruct a three-dimensional (virtual or mathematical) model of a space occupied by the LiDAR sensor 10, such as in the form of 3D image represented by a rectangular matrix of range values, wherein each range value in the matrix corresponds to a polar coordinate in 3D space. Each photodetector 26 can be configured to detect a single photon per sampling period, e.g., in the example in which the photodetector 26 is a SPAD. The photodetector 26 functions to output a single signal or stream of signals corresponding to a count of photons incident on the photodetector 26 within one or more sampling periods. Each sampling period may be picoseconds, nanoseconds, microseconds, or milliseconds in duration. The photodetector 26 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the fields of view of these photodetectors 26. By merging these distances with the position of photodetectors 26 at which these data originated and relative positions of these photodetectors 26 at a time that these data were collected, the controller 18 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

With reference to FIGS. 5 and 5A, the photodetectors 26 may be arranged as an array, e.g., a 2-dimensional arrangement. A 2D array of photodetectors 26 includes a plurality of photodetectors 26 arranged in columns and rows. Specifically, the light detector 16 may be a focal-plane array (FPA).

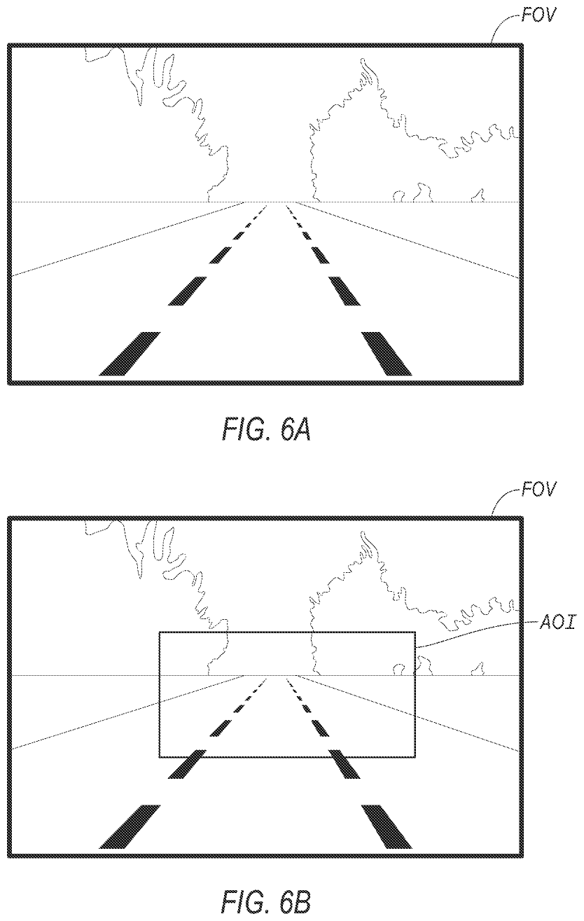

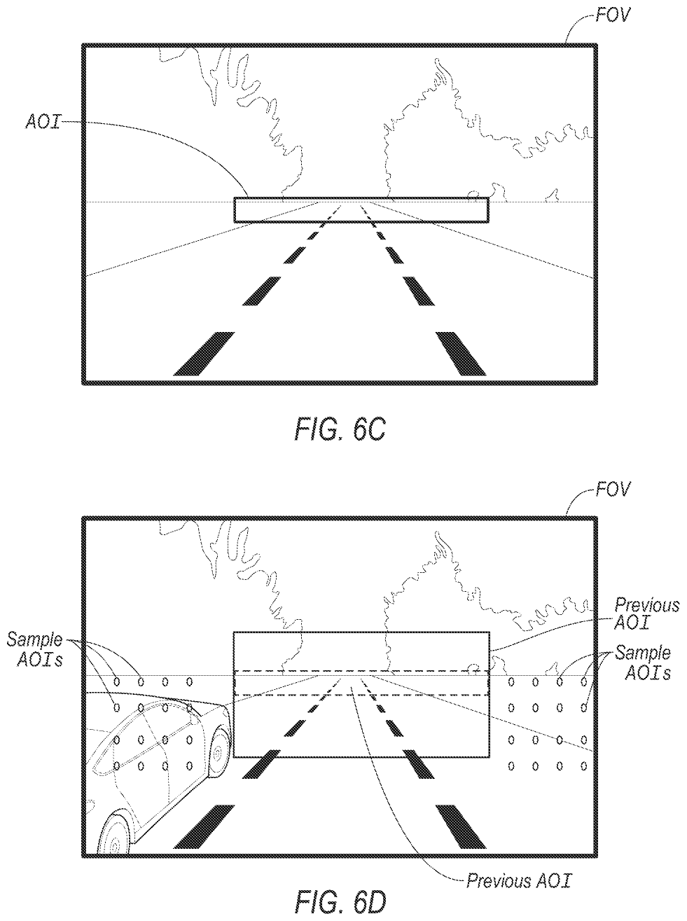

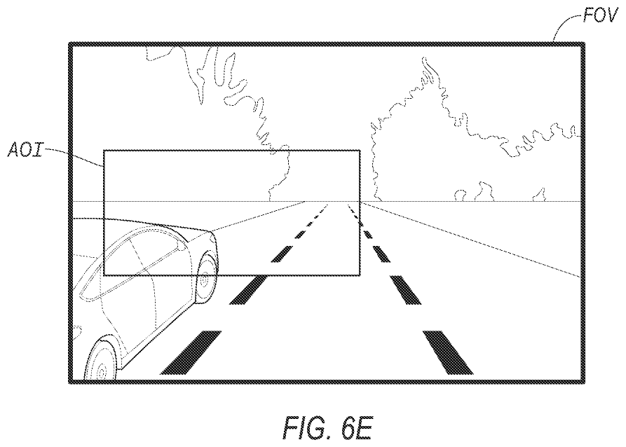

The light detector 16 includes a plurality of pixels. Each pixel may include one or more photodetectors 26. As shown schematically in FIG. 6, the light detector 16, e.g., each of the pixels, include a power-supply circuit 34 and a read-out integrated circuit (ROIC) 36. The photodetectors 26 are connected to the power-supply circuit 34 and the ROIC 36. Multiple pixels may share a common power-supply circuit 34 and/or ROIC 36.

The light detector 16 detects photons by photo-excitation of electric carriers. An output from the light detector 16 indicates a detection of light and may be proportional to the amount of detected light, in the case of a PIN diode or APD, and may be a digital signal in case of a SPAD. The outputs of light detector 16 are collected to generate a 3D environmental map, e.g., 3D location coordinates of objects and surfaces within the field of view FOV of the LiDAR sensor 10.

With reference to FIG. 6, the ROIC 36 converts an electrical signal received from photodetectors 26 of the FPA to digital signals. The ROIC 36 may include electrical components which can convert electrical voltage to digital data. The ROIC 36 may be connected to the controller 18, which receives the data from the ROIC 36 and may generate 3D environmental map based on the data received from the ROIC 36.

The power-supply circuits 34 supply power to the photodetectors 26. The power-supply circuit 34 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 34 may supply power to the photodetectors 26 in a first voltage range that is higher than a second operating voltage of the ROIC 36. The power-supply circuit 34 may receive timing information from the ROIC 36.

The light detector 16 may include one or more circuits that generates a reference clock signal for operating the photodetectors 26. Additionally, the circuit may include logic circuits for actuating the photodetectors 26, power-supply circuit 34, ROIC 36, etc.

As set forth above, the light detector 16 includes a power-supply circuit 34 that powers the pixels. The light detector 16 may include a single power-supply circuit 34 in communication with all pixels or may include a plurality of power-supply circuits 34 in communication with a group of the pixels.

The power-supply circuit 34 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 34 may include a power-supply control circuit. The power-supply control circuit may include electrical components such as a transistor, logical components, etc. The power-supply control circuit may control the power-supply circuit 34, e.g., in response to a command from the controller 18, to apply bias voltage and quench and reset the SPAD.

In examples in which the photodetector 26 is an avalanche-type photodiode, e.g., a SPAD, to control the power-supply circuit 34 to apply bias voltage, quench, and reset the avalanche-type diodes, the power-supply circuit 34 may include a power-supply control circuit. The power-supply control circuit may include electrical components such as a transistor, logical components, etc. A bias voltage, produced by the power-supply circuit 34, is applied to the cathode of the avalanche-type diode. An output of the avalanche-type diode, e.g., a voltage at a node, is measured by the ROIC 36 circuit to determine whether a photon is detected. The power-supply circuit 34 supplies the bias voltage to the avalanche-type diode based on inputs received from a driver circuit of the ROIC 36. The ROIC 36 may include the driver circuit to actuate the power-supply circuit 34, an analog-to-digital (ADC) or time-to-digital (TDC) circuit to measure an output of the avalanche-type diode at the node, and/or other electrical components such as volatile memory (register), and logical control circuits, etc. The driver circuit may be controlled based on an input received from the circuit of the light detector 16, e.g., a reference clock. Data read by the ROIC 36 may be then stored in, for example, a memory chip. A controller 18, e.g., the controller 18, a controller 18 of the LiDAR sensor 10, etc., may receive the data from the memory chip and generate 3D environmental map, location coordinates of an object within the field of view FOV of the LiDAR sensor 10, etc.

The controller 18 actuates the power-supply circuit 34 to apply a bias voltage to the plurality of avalanche-type diodes. For example, the controller 18 may be programmed to actuate the ROIC 36 to send commands via the ROIC 36 driver to the power-supply circuit 34 to apply a bias voltage to individually powered avalanche-type diodes. Specifically, the controller 18 supplies bias voltage to avalanche-type diodes of the plurality of pixels of the focal-plane array through a plurality of the power-supply circuit 34s, each power-supply circuit 34 dedicated to one of the pixels, as described above. The individual addressing of power to each pixel can also be used to compensate manufacturing variations via look-up-table programmed at an end-of-line testing station. The look-up-table may also be updated through periodic maintenance of the LiDAR sensor 10.

The controller 18 is in communication, e.g., electronic communication, with the light emitter 12, the light detector 16 (e.g., with the ROIC 36 and power-supply circuit 34), and the vehicle 20 (e.g., with the ADAS 22) to receive data and transmit commands. The controller 18 may be configured to execute operations disclosed herein.

The controller 18 is a physical, i.e., structural, component of the LiDAR sensor 10. The controller 18 may be a microprocessor-based controller 18, an application specific integrated circuit (ASIC), field programmable gate array (FPGA), etc., or a combination thereof, implemented via circuits, chips, and/or other electronic components.

For example, the controller 18 may include a processor, memory, etc. In such an example, the memory of the controller 18 may store instructions executable by the processor, i.e., processor-executable instructions, and/or may store data. The memory includes one or more forms of controller 18-readable media, and stores instructions executable by the controller 18 for performing various operations, including as disclosed herein. As another example, the controller 18 may be or may include a dedicated electronic circuit including an ASIC (application specific integrated circuit) that is manufactured for a particular operation, e.g., calculating a histogram of data received from the LiDAR sensor 10 and/or generating a 3D environmental map for a field of view FOV of the light detector 16 and/or an image of the field of view FOV of the light detector 16. As another example, the controller 18 may include an FPGA (field programmable gate array) which is an integrated circuit manufactured to be configurable by a customer. As an example, a hardware description language such as VHDL (very high-speed integrated circuit hardware description language) is used in electronic design automation to describe digital and mixed-signal systems such as FPGA and ASIC. For example, an ASIC is manufactured based on hardware description language (e.g., VHDL programming) provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 18 may be a set of controllers communicating with one another via a communication network of the vehicle 20, e.g., a controller 18 in the LiDAR sensor 10 and a second controller 18 in another location in the vehicle 20.

The controller 18 may be in communication with the communication network of the vehicle 20 to send and/or receive instructions from the vehicle 20, e.g., components of the ADAS 22. The controller 18 is programmed to perform the method 700 and function described herein and shown in the figures. For example, in an example including a processor and a memory, the instructions stored on the memory of the controller 18 include instructions to perform the method 700 and function described herein and shown in the figures; in an example including an ASIC, the hardware description language (e.g., VHDL) and/or memory electrically connected to the circuit include instructions to perform the method 700 and function described herein and shown in the figures; and in an example including an FPGA, the hardware description language (e.g., VHDL) and/or memory electrically connected to the circuit include instructions to perform the method0 and function described herein and shown in the figures. Use herein of “based on,” “in response to,” and “upon determining,” indicates a causal relationship, not merely a temporal relationship.

The controller 18 may provide data, e.g., a 3D environmental map and/or images, to the ADAS 22 of the vehicle 20 and the ADAS 22 may operate the vehicle 20 in an autonomous or semi-autonomous mode based on the data from the controller 18. For purposes of this disclosure, an autonomous mode is defined as one in which each of vehicle 20 propulsion, braking, and steering are controlled by the controller 18 and in a semi-autonomous mode the controller 18 controls one or two of vehicle 20 propulsion, braking, and steering. In a non-autonomous mode a human operator controls each of vehicle 20 propulsion, braking, and steering.

The controller 18 may include or be communicatively coupled to (e.g., through the communication network) more than one processor, e.g., controller 18s or the like included in the vehicle 20 for monitoring and/or controlling various vehicle 20 controllers, e.g., a powertrain controller, a brake controller, a steering controller, etc. The controller 18 is generally arranged for communications on a vehicle 20 communication network that can include a bus in the vehicle 20 such as a controller area network (CAN) or the like, and/or other wired and/or wireless mechanisms.

The controller 18 is programmed to compile a frame (i.e., a detection frame) of light detection in the field of view. Specifically, each frame may be a compilation of sub frames (i.e., detection subframes). Each subframe is a compilation for all photodetectors 26, e.g., all pixels, of object distance and location (i.e., based on photodetector 26 location) of detections for a shot or series of shots by the light emitter 12. In other words, a subframe may be generated for each shot or a consecutive series of shots of the light emitter 12 and each subframe is a compilation of detections across all photodetectors 26 for that shot or series of consecutive shots. One frame may be generated from, for example, subframes generated over 1,500-2,500 shots by the light emitter 12. Stated differently, a plurality of subframes may be generated over 1,500-2,500 shots by the light emitter 12 and these subframes may be combined into one frame. The subframes may be combined into a frame and the frames may be used for environmental mapping. As an example, movement of an object, including velocity, acceleration, and direction, may be identified by comparing changes in object distance (i.e., from the light detector 16) and/or photodetector 26 location (i.e., which photodetector(s) 26 detects the object) between frames and/or between subframes. For example, the controller 18 is programmed to identify the relative velocity of an object moving in the field of view FOV by comparing changes in object distance and/or photodetector 26 location between frames and/or subframes. Examples of five subframes are shown in FIGS. 6A-6E.

The controller 18 repeated activate the light emitter 12 and the spatial light modulator 14 for each shot of the light emitter 12 and repeats activation of the light detector 16 for each shot of the light emitter 12. The controller 18 identifies an area of interest AOI of the field of view FOV based on detection of at least one previous shot by the light emitter 12 and, for at least a subsequent shot by the light emitter 12, the controller 18 adjusts the spatial light modulator 14 to target the area of interest AOI. The area of interest AOI is in the field of view FOV of the light detector 16 and is smaller than the field of view FOV of the light detector 16. The area of interest AOI may be, as examples, a part of the field of view FOV of the light detector 16 in which an object was detected for a previous shot, a part of the field of view FOV of the light detector 16 identified as the horizon of the earth based on detection in one or more previous shots, a part of the field of view FOV that has not been illuminated by the light emitter 12 recently (e.g., within a predetermined number of previous subframes, frames, etc.), vehicle 20 input, and combinations thereof.

As set forth above, the controller 18 is programmed to activate the light emitter 12 and the spatial light modulator 14 to illuminate at least a portion of the field of view FOV. Specifically, the controller 18 instructs the light emitter 12 to emit light, i.e., to emit a shot and instructs the spatial light modulator 14 to direct the light from the light emitter 12 for that shot into the field of illumination. As set forth below, the controller 18 may control the spatial light modulator 14 to target an area of interest AOI identified based detections from a previous subframe. In other words, the spatial light modulator 14 controls the field of illumination FOI emitted from the LiDAR sensor 10 to generally match the area of interest AOI identified in the previous subframe. The field of illumination FOI may be larger than the area of interest AOI. Specifically, the field of illumination FOI may include a slight overlap, e.g. a 10% overlap, beyond the boundary of the area of interest AOI to ensure coverage of the area of interest AOI.

The controller 18 is programmed to detect light reflected in the area of interest AOI, i.e., the portion of the field of view FOV of the light detector 16 illuminated by light directed from the light emitter 12 by the spatial light modulator 14. Specifically, the controller 18 is programmed to detect light with the light detector 16 by operating the light detector 16 as described above. For example, the controller 18 instructs the photodetectors 26, e.g., the pixels, to detect light directed from the spatial light modulator 14 into the field of view FOV and reflected by an object in the field of view.

The controller 18 is programmed to repeat activation of the light emitter 12 and the spatial light modulator 14. The controller 18 is programmed to repeat activation of the light detector 16 to detect light in the field of view FOV of the light detector 16. The controller 18 may instruct the light detector 16 to detect light in the field of view FOV of the light detector 16 for each light emission by the light emitter 12. Specifically, the controller 18 may instruct at least some of the photodetectors 26 to be active to detect light reflected in the field of view FOV of the light detector 16 for each emission of light by the light emitter 12. As one example, the controller 18 may instruct all of the photodetectors 26 to be active for each emission of light by the light emitter 12. As another example, the controller 18 may instruct photodetectors 26 aimed at the area of interest AOI to be active for an emission of light by the light emitter 12 directed into the area of interest AOI by the spatial light modulator 14.

The controller 18 may be programmed to use the detection of light in the field of view FOV by the light detector 16 is to generate a plurality of detection subframes. Specifically, the generation of the subframe may be performed by the controller 18 or sent by the controller 18 to another component for generation of the subframe. The controller 18 may be programmed to generate a subframe for each shot or a series of shots of the light emitter 12. As set forth above, each subframe is a compilation of detected shots across all photodetectors 26 for that shot or series of shots. The controller 18 may be programmed to combine the subframes into a single detection frame. Specifically, the combination of the subframe may be performed by the controller 18 or the controller 18 may communicate data to another component for generation of the frame. The subframes may be, for example, overlapped, e.g., with any suitable software, method, etc.

The controller 18 is programmed to identify an area of interest AOI in the field of view FOV of the light detector 16. Specifically, the controller 18 is programmed to, for a subsequent subframe, identify an area of interest AOI based on light detected by the light detector 16 in a previous subframe. The area of interest AOI may be based detection in one previous subframe, a comparison of a plurality of previous subframes, or a combination of previous subframes. As set forth above, the area of interest AOI may be, as examples, a part of the field of view FOV of the light detector 16 in which an object was detected for a previous subframe, part of the field of view FOV of the light detector 16 identified as the horizon of the earth based on detection in one or more previous subframes, a part of the field of view FOV of the light detector 16 that has not been illuminated by the light emitter 12 recently (e.g., within a predetermined number of previous subframes, frames, etc.), vehicle input, and combinations thereof.

The controller 18 may base the area of interest AOI, for example, on detection of an object in one or more previous subframes. The controller 18 may be programmed with parameters to identify whether a detection in one or more previous subframes is an area of interest AOI in future subframes. For example, the controller 18 may be programmed to identify an area of interest AOI based on size of a detected object and/or the range of a detected object in one or more subframes, e.g., a determination that the size of the object is larger than a threshold, closer than a threshold, etc. As another example, the controller 18 may be programmed to identify an area of interest AOI based on the movement of detected object over more than one subframe. In such an example, the controller 18 may be programmed to identify an area of interest AOI based on the velocity and/or acceleration of the detected object as calculated by comparisons of previous subframes. As another example, the controller 18 may be programmed to identify an area of interest based on identification of an object. As an example, the controller 18 may be programmed to identify an object by shape recognition (e.g., medians, lane markers, guard rails, street signs, the horizon of the earth, etc.).

The controller 18 may base the area of interest AOI based on vehicle input from the vehicle 20. As an example, the controller 18 may receive vehicle-steering angle changes and may base the area of interest AOI based on changes in vehicle steering. As another example, the controller 18 may receive vehicle dynamic input such as suspension data, e.g., ride height changes, ride angle changes, etc., and may base the area of interest AOI based on changes thereof. As another example, the controller 18 may receive input regarding vehicle 20 speed and/or acceleration and may base the area of interest AOI based on changes thereof.

The controller 18 may base the area of interest AOI based on external input, i.e., input received by the vehicle 20 from an external source. As an example, the controller 18 may receive map information from the vehicle 20 and may base the area of interest AOI based on the map information. For example, the map information may include high-definition map data including object location. The high-definition map may include known objects and/or objects received from input from other vehicles. The external input may be vehicle-to-vehicle information that is received by the vehicle 20 from another vehicle identifying objection detection by the other vehicle.

For some subframes, the controller 18 may be programmed to sample areas of the field of view FOV of the light detector 16 that have not been illuminated recently, (e.g., within a predetermined number of previous subframes, frames, etc.). In other words, for at least some subframes, the controller 18 may be programmed to instruct the spatial light modulator 14 to move the field of illumination FOI outside of the area of interest AOI identified from a previous subframe to sample the field of view FOV of the light emitter 16 outside of that area of interest AOI. Specifically, the controller 18 may be programmed to determine whether previous areas of interest AOIs are too concentrated, i.e., focused on a particular part of the field of view FOV without illuminating portions of the FOV. Examples of previous areas of interest AOIs being to concentrated includes, for example, at least one area of the field of view FOV has not been illuminated for more than a predetermined number of subframes, a portion of the field of view FOV of the light detector 16 has not been illuminated for a predetermined period of time, etc.

The controller 18 may be programmed to expand and/or move the area of interest AOI previously identified by the controller 18 based only on detected light in a previous subframe. Specifically, controller 18 may be programmed to expand the area of interest AOI and/or move the area of interest AOI to cover portions of the field of view FOV not recently illuminated, e.g., for a predetermined number of previous subframes, a predetermined preceding time, etc. For example, in a situation in which input to the controller 18 causes the controller 18 to identify the area of interest AOI in a similar area significantly smaller than the field of view FOV of the light detector 16 repeatedly for consecutive subframes, the controller 18 may illuminate the entire field of view FOV or may adjust the area of interest AOI to cover a greater portion of the field of view FOV for one or more subsequent subframes. This allows for other parts of the field of view FOV of the light detector 16 to be monitored periodically.

As set forth above, the controller 18 may identify the area of interest AOI based on a combination of factors. The controller 18 may be programmed to rank or weigh certain factors to identify an area of interest AOI when multiple factors are detected. As an example, the controller 18 may be biased to aim the area of interest AOI at the horizon of the earth based on previous subframes. The controller 18 may move the area of interest AOI based on the horizon of the earth in addition to detection of another object in a previous subframe, specifically, the location, range, size, speed, acceleration, identification, etc., of the object.

The controller 18 is programmed to adjust the spatial light modulator 14 to direct light into the field of illumination at an intensity that is greater at the area of interest AOI than at an adjacent area of the field of view. In other words, for a future subframe, the spatial light modulator 14 increases intensity of light from the light emitter 12 in the area of interest AOI based on detection in a previous subframe. The spatial light modulator 14 may direct light at higher intensity light at the area of interest AOI than light at the adjacent area and/or may emit no light at the adjacent area. In the example described above in which the spatial light modulator 14 is a liquid crystal lens, the controller 18 may adjust the spatial light modulator 14 by controlling actuation of the pixels of the liquid crystal lens.

The controller 18 is programmed to repeatedly update the area of interest AOI based on continued collection of subframes. In other words, after identifying an area of interest AOI and collecting a subsequent subframe, the controller 18 is programmed to identify a new area of interest AOI based on the subsequent subframe and, for a subframe after the subsequent subframe (e.g., the next subframe), adjust the spatial light modulator 14 to direct light into the field of view FOV at an intensity that is greater at the new area of interest AOI than at an adjacent area of the field of view for the subframe after the subsequent frame. The area of interest AOI of the subsequent subframe may be based on the same criteria as the area of interest AOI as described above, e.g., object detection in a previous subframe, identification of the, an area that has not been illuminated by the light emitter 12 recently, vehicle 20 input, etc.

As set forth above, the controller 18 is programmed to identify an area of interest AOI based on at least one previous subframe. For example, the subframe that is used to identify the area of interest AOI may be a subframe from a previous frame. In other words, a frame may be compiled and, for a subframe of a subsequent frame, the controller 18 may base the area of interest AOI of the subframe of the subsequent frame based on one or more subframe the previous frame. In another example, the subframe that is used to identify the area of interest AOI may be a previous subframe of the same frame. In other words, in the same frame, a previous subframe may be used to identify the area of interest AOI of a subsequent subframe of that same frame.

Examples of areas of interest AOIs are shown in FIGS. 6A-E. For example, in FIG. 6A, the entire field of view FOV of the light detector 16 is illuminated. As an example, the entire field of view FOV may be illuminated at the first emission of the light emitter 12 to acquire a baseline detection of the field of view FOV from which areas of interest may be identified. The entire field of view FOV may be periodically illuminated to reset the baseline detection of the field of view FOV.

FIG. 6B shows an example subframe after the subframe shown in FIG. 6A. In the example shown in FIG. 6B, as an example, the horizon has been identified based on the detection of the entire field of view FOV in FIG. 6A. The area of interest AOI in FIG. 6B is based on the horizon and the path of the roadway. FIG. 6C shows an example subframe subsequent to that in FIG. 6B. In the example in FIG. 6C, the area of interest AOI has been narrowed to follow the horizon and the roadway. The area of interest AOI in FIG. 6C could also be, for example, based on vehicle 20 input. FIG. 6D shows examples of sample areas of interest AOIs outside of recent previous areas of interest AOIs. Merely for example, 32 sample AOIs are shown in FIG. 6D. Any one of those samples could be taken in any one subframe and such a sample may have any suitable location, size, shape, etc. Specifically, the controller 18 may sample one of the sample AOIs in a subframe after several subframes in which the area of interest AOI of FIG. 6C has been illuminated. In the event the sample AOI does not result in object detection by the light detector 16, the controller 18 may resume illumination of the AOI in the subframe previous to the sample AOI. In the event the sample AOI does result in object detection by the light detector 16, the controller 18 in a subsequent subframe may illuminate the entire field of view FOV of the light detector 16 or may identify the area of interest AIO for a subsequent subframe to include the area of the field of view FOV in which the object was detected in the sample AOI.

In the example shown in FIG. 6D, several of the sample areas would detect an overcoming vehicle in the left lane. In the example in FIG. 6E, the area of interest AOI in a subsequent frame is moved to the overcoming vehicle 20 based on illumination of one of the sample areas in a previous subframe. The examples shown in FIGS. 6A-e are merely examples to illustrate an operation of the controller 18 and method 700. In any of FIGS. 6A-E, other objects in the field of view FOV of the light detector 16 may be detected and the area of interest AOI adjusted by control of the spatial light modulator 14 as described herein.

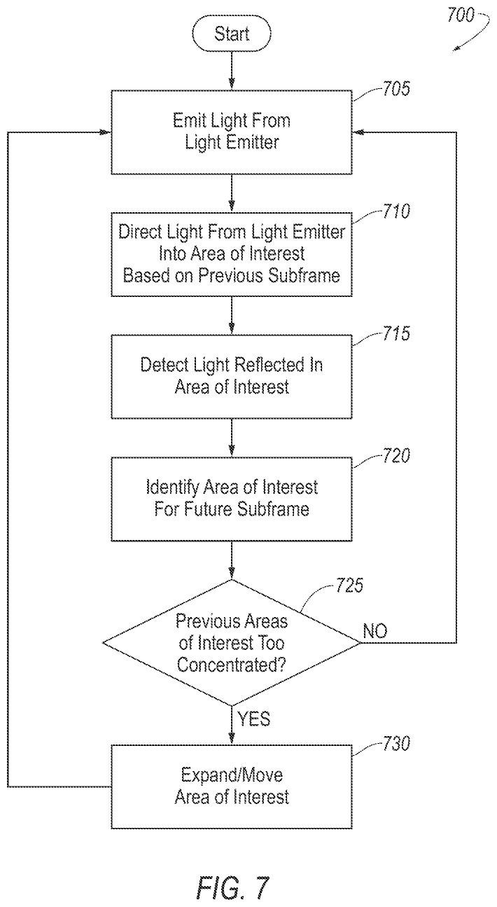

With reference to FIG. 7, an example method 700 of operating the LiDAR sensor 10 is generally shown. The method 700 includes activating the light emitter 12 and the spatial light modulator 14 for each shot of the light emitter 12 and activating the light detector 16 for each shot of the light emitter 12. Specifically, the method 700 includes activating the light emitter 12, the spatial light modulator 14, and the light detector 16 repeatedly, i.e., for multiple shots, to generate multiple subframes. The method 700 includes identifying an area of interest AOI of the field of view FOV based on detection of at least one previous shot by the light emitter 12 and, for at least a subsequent shot by the light emitter 12, adjusting the spatial light modulator 14 to target the area of interest AOI.

The method 700 includes activating the light emitter 12, as shown in block 705, and the spatial light modulator 14, as shown in block 710, to illuminate at least a portion of the field of view FOV of a light detector 16. Specifically, the method 700 includes instructing the light emitter 12 to emit light, i.e., to emit a shot and instructs the spatial light modulator 14 to direct the light from the light emitter 12 for that shot into the field of illumination. The method 700 includes controlling the spatial light modulator 14 to target an area of interest AOI identified based detections from a previous shot. For the first occurrence of block 710, the area of interest AOI, i.e., the original area of interest AOI of method 700, may be the entire field of view FOV of the light detector 16.

With reference to block 715, the method includes detecting light reflected in the area of interest AOI, i.e., the portion of the field of view illuminated by light directed from the light emitter 12 by the spatial light modulator 14. Specifically, the method includes detecting light with the light detector 16 by operating the light detector 16 as described above. For example, the method 700 includes instructing the photodetectors 26, e.g., the pixels, to detect light directed from the spatial light modulator 14 into the field of view FOV and reflected by an object in the field of view.

As shown in the feedback loop from block 725 to block 705 and from block 730 to block 705, the method 700 includes repeating activation of the light emitter 12 and the spatial light modulator 14 and repeating activation of the light detector 16 to detect light in the field of view. The method 700 includes instructing the light detector 16 to detect light in the field of view for each light emission by the light emitter 12. Specifically, the method 700 includes instructing at least some of the photodetectors 26 to be active to detect light reflected in the field of view FOV for each emission of light by the light emitter 12. As one example, the method 700 may include instructing all of the photodetectors 26 to be active for each emission of light by the light emitter 12. As another example, the method 700 may include instructing photodetectors 26 aimed at the area of interest AOI to be active for an emission of light by the light emitter 12 directed into the area of interest AOI by the spatial light modulator 14.

By repeating, the method 700 may generate a plurality of detection subframes and may combine the detection subframes into detection frames. Specifically, the method 700 pay use the detection of light in the field of view FOV by the light detector 16 is to generate a plurality of detection subframes. The method 700 may include generating a subframe for each shot or a series of shots of the light emitter 12. As set forth above, each subframe is a compilation of detected shots across all photodetectors 26 for that shot or series of shots. The method 700 includes combining the detection subframes into a single detection frame. Specifically, the method 700 may include overlapping the subframes, e.g., with any suitable software, method, etc.

The method 700 includes, for a subsequent subframe, identifying an area of interest AOI based on light detected by the light detector 16 in a previous subframe, with reference to block 720. As shown in the feedback loop from block 725 to block 705 and from block 730 to block 705, the method includes adjusting the spatial light modulator 14 to direct light into the field of illumination at an intensity that is greater at the area of interest AOI than at an adjacent area of the field of view FOV. In other words, after the area of interest AOI for a future subframe, e.g., the next subframe, is identified in block 720, that area of interest AOI is used in the next operation of blocks 710 and 715.

The method 700 may include basing the area of interest AOI on detection in one previous subframe, a comparison of a plurality of previous subframes, or a combination of previous subframes. The method may base the area of interest AOI on, as examples, an area of the field of view in which an object was detected for a previous subframe, an area of the field of view identified as the horizon based on detection in one or more previous subframes, an area of the field of view that has not been illuminated by the light emitter 12 recently (e.g., within a predetermined number of previous subframes, frames, etc.), vehicle 20 input, and combinations thereof.

The method 700 may base the area of interest AOI, for example, on detection of an object in one or more previous subframes. The method may use predetermined parameters to identify whether a detection in one or more previous subframes is an area of interest AOI in future subframes. For example, the method may include identifying an area of interest AOI based on size of a detected object and/or the range of a detected object in one or more subframes, e.g., a determination that the size of the object is larger than a threshold, closer than a threshold, etc. As another example, the method 700 may include identifying an area of interest AOI based on the movement of detected object over more than one subframe. In such an example, the method 700 includes identifying an area of interest AOI based on the velocity and/or acceleration of the detected object as calculated by comparisons of previous subframes. As another example, the method may include identifying an area of interest based on identification of an object. As an example, the method may include identifying an object by shape recognition (e.g., medians, lane markers, guard rails, street signs, the horizon of the earth, etc.).

The method 700 may base the area of interest AOI based on vehicle 20 input. As an example, the method may include receiving vehicle 20-steering angle changes and may base the area of interest AOI based on changes in vehicle 20 steering. As another example, the method may include receiving vehicle 20 dynamic input such as suspension data, e.g., ride height changes, ride angle changes, etc., and may base the area of interest AOI based on changes thereof. As another example, the method 700 may include receiving input regarding vehicle 20 speed and/or acceleration and may base the area of interest AOI based on changes thereof.

The method 700 may base the area of interest AOI based on external input, i.e., input received by the vehicle 20 from an external source. As an example, the method 700 may include receiving map information from the vehicle 20 and may base the area of interest AOI based on the map information. For example, as set forth above, the information from an external source may include map data from a high-definition map, vehicle 20-to-vehicle 20 information, etc.

The method 700 may include identifying the area of interest AOI based on a combination of factors. The method 700 may include ranking or weighing certain factors to identify an area of interest AOI when multiple factors are detected. As an example, the method 700 may bias the aim of the area of interest AOI at the horizon of the earth based on previous subframes. The method 700 may move the area of interest AOI based on the horizon in addition to detection of another object in a previous subframe, specifically, the location, range, size, speed, acceleration, identification, etc., of the object.

With reference to blocks 725 and 730, the method may include, for some subframes, sampling areas of the field of view FOV that have not been illuminated recently, (e.g., within a predetermined number of previous subframes, frames, etc.). In other words, for at least some subframes, the method may include instructing the spatial light modulator 14 to expand the area of interest AOI to sample the field of view FOV outside of the recent previous areas of interest. Specifically, in decision block 725, the method 700 includes determining whether previous areas of interest are too concentrated, i.e., focused on a particular part of the field of view FOV without illuminating portions of the FOV. Examples of previous areas of interest being to concentrated includes, for example, at least one area of the field of view FOV has not been illuminated for more than a predetermined number of subframes, a portion of the field of view FOV has not been illuminated for a predetermined period of time, etc. If the previous areas of interest are not too concentrated, the method 700 proceeds to block 705, as shown with the feedback loop from block 725 to block 705. If the previous areas of interest are too concentrated, the method 700 proceeds to block 730.

In block 730, the method 700 includes expanding and/or moving the area of interest AOI from area of interest AOI identified in block 720. Specifically, the area of interest AOI may be expanded and/or moved to cover portions of the field of view FOV not recently illuminated, e.g., for a predetermined number of previous subframes, a predetermined preceding time, etc. The expanded and/or moved area of interest AOI from block 730 is then used the following occurrence of blocks 710 and 715, as shown by the feedback loop from block 730 to block 705. For example, in a situation in which the method 700 includes receiving input that causes the method 700 to repeatedly identify the area of interest AOI in a similar area significantly smaller than the field of view FOV of the light detector 16 repeatedly for consecutive subframes, the method 700 may include illuminating the entire field of view FOV, adjusting the area of interest AOI to cover a greater portion of the field of view FOV for one or more subsequent subframes, or moving the area of interest AOI to a recently unilluminated area of the field of view FOV for one or more subsequent subframes.

The method 700 includes repeatedly updating the area of interest AOI based on continued collection of subframes. In other words, after identifying an area of interest AOI and collecting a subsequent subframe, the method 700 includes identifying a new area of interest AOI based on the subsequent subframe and, for a subframe after the subsequent subframe (e.g., the next subframe), adjusting the spatial light modulator 14 to direct light into the field of illumination at an intensity that is greater at the new area of interest AOI than at an adjacent area of the field of view for the subframe after the subsequent frame. The method 700 may base the area of interest AOI of the subsequent subframe on the same criteria as the area of interest AOI as described above, e.g., object detection in a previous subframe, identification of the, an area that has not been illuminated by the light emitter 12 recently, vehicle 20 input, etc.

The method 700 includes identifying an area of interest AOI based on at least one previous subframe. For example, the method may use the subframe from a previous frame or from the same frame, as described above.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A LiDAR sensor comprising:
a light emitter;
a spatial light modulator positioned to direct light from the light emitter into a field of illumination;
a light detector having a field of view overlapping the field of illumination; and
a controller programmed to:
activate the light emitter and the spatial light modulator to illuminate at least a portion of the field of view;
repeat activation of the light detector to detect light in the field of view to generate a plurality of detection subframes that are combined into a single detection frame;
for a subsequent subframe, identify an area of interest based on light detected by the light detector in a previous subframe, the area of interest being in the field of view of the light detector and being smaller than the field of view of the light detector; and
adjust the spatial light modulator to direct light into the field of illumination at an intensity that is greater at the area of interest than at an adjacent area of the field of view.

2. The LiDAR sensor as set forth in claim 1, wherein the controller is programmed to, for a subframe after the subsequent subframe, instruct the spatial light modulator to move the area of interest based on vehicle input.

3. The LiDAR sensor as set forth in claim 1, wherein the controller is programmed to, for at least some subframes after the subsequent subframe, instruct the spatial light modulator to move the field of illumination outside of the area of interest to sample the field of view outside of the area of interest.

4. The LiDAR sensor as set forth in claim 1, wherein the previous subframe on which the area of interest is based is in the same frame as the subsequent subframe.

5. The LiDAR sensor as set forth in claim 1, wherein the previous subframe on which the area of interest is based is in a previous frame.

6. The LiDAR sensor as set forth in claim 1, wherein the field of illumination is larger than the area of interest.

7. The LiDAR sensor as set forth in claim 1, wherein the area of interest includes the horizon as detected in the previous subframe.

8. The LiDAR sensor as set forth in claim 7, wherein the area of interest includes at least one object in addition to the horizon as detected in the previous subframe.

9. The LiDAR sensor as set forth in claim 1, wherein the controller is programmed to identify a new area of interest based on the subsequent subframe and, for a subframe after the subsequent subframe, adjust the spatial light modulator to direct light into the field of illumination at an intensity that is greater at the new area of interest than at an adjacent area of the field of view for the subframe after the subsequent frame.

10. A method of operating a LiDAR sensor, the method comprising:
activating a light emitter and a spatial light modulator to illuminate at least a portion of the field of view of a light detector;
repeating activation of the light detector to detect light in the field of view to generate a plurality of detection subframes that are combined into a single detection frame;
for a subsequent subframe, identifying an area of interest based on light detected by the light detector in a previous subframe, the area of interest being in the field of view of the light detector and being smaller than the field of view of the light detector; and
adjusting the spatial light modulator to direct light into the field of illumination at an intensity that is greater at the area of interest than at an adjacent area of the field of view.

11. The method as set forth in claim 10, further comprising, for a subframe after the subsequent subframe, instructing the spatial light modulator to move the area of interest based on vehicle input.

12. The method as set forth in claim 10, further comprising, for at least some subframes after the subsequent subframe, instructing the spatial light modulator to move the field of illumination outside of the area of interest to sample the field of view outside of the area of interest.

13. The method as set forth in claim 10, wherein the previous subframe on which the area of interest is based is in the same frame as the subsequent subframe.

14. The method as set forth in claim 10, wherein the previous subframe on which the area of interest is based is in a previous frame.

15. The method as set forth in claim 10, wherein the field of illumination is larger than the area of interest.

16. The method as set forth in claim 10, wherein the area of interest includes the horizon as detected in the previous subframe.

17. The method as set forth in claim 16, wherein the area of interest includes at least one object in addition to the horizon as detected in the previous subframe.

18. The method as set forth in claim 10, further comprising identifying a new area of interest based on the subsequent subframe and, for a subframe after the subsequent subframe, adjusting the spatial light modulator to direct light into the field of illumination at an intensity that is greater at the new area of interest than at an adjacent area of the field of view for the subframe after the subsequent frame.

19. A controller for a LiDAR sensor, the controller programmed to:
activate a light emitter and a spatial light modulator to illuminate at least a portion of the field of view of a light detector;
repeat activation of the light detector to detect light in the field of view to generate a plurality of detection subframes that are combined into a single detection frame;
for a subsequent subframe, identify an area of interest based on light detected by the light detector in a previous subframe, the area of interest being in the field of view of the light detector and being smaller than the field of view of the light detector; and
adjust the spatial light modulator to direct light into the field of illumination at an intensity that is greater at the area of interest than at an adjacent area of the field of view.

20. The controller as set forth in claim 19, the controller programed to, for a subframe after the subsequent subframe, instruct the spatial light modulator to move the area of interest based on vehicle input.

21. The controller as set forth in claim 19, wherein the controller is programmed to, for at least some subframes after the subsequent subframe, instruct the spatial light modulator to move the field of illumination outside of the area of interest to sample the field of view outside of the area of interest.

22. The controller as set forth in claim 19, wherein the previous subframe on which the area of interest is based is in the same frame as the subsequent subframe.

23. The controller as set forth in claim 19, wherein the previous subframe on which the area of interest is based is in a previous frame.

24. The controller as set forth in claim 19, wherein the field of illumination is larger than the area of interest.

25. The controller as set forth in claim 19, wherein the area of interest includes the horizon as detected in the previous subframe.

26. The controller as set forth in claim 25, wherein the area of interest includes at least one object in addition to the horizon as detected in the previous subframe.

27. The controller as set forth in claim 19, wherein the controller is programmed to identify a new area of interest based on the subsequent subframe and, for a subframe after the subsequent subframe, adjust the spatial light modulator to direct light into the field of illumination at an intensity that is greater at the new area of interest than at an adjacent area of the field of view for the subframe after the subsequent frame.
